(19) United States
(12) Patent Application Publication
(10) Pub. No.: US 2018/0026451 A1
(43) Pub. Date: Jan. 25, 2018

(54) THERMAL MANAGEMENT FOR CONCURRENT WORKLOAD EXECUTION AND FAST CHARGING

(71) Applicant: MediaTek Inc., Hsinchu (TW)

(72) Inventors: Chih-Yuan Hsiao, New Taipei City (TW); Chien-Tse Fang, Taipei (TW); Wei-Ting Wang, Taipei (TW); Yung-Cheng Huang, Taoyuan (TW); Jia-You Chuang, Zhubei (TW)

(21) Appl. No.: 15/472,235

(22) Filed: Mar. 28, 2017

Related U.S. Application Data
(60) Provisional application No. 62/364,903, filed on Jul. 21, 2016.

(51) Int. Cl. H02J 7/00

(52) U.S. Cl. CPC H02J 7/007; H02J 7/0021

(57) ABSTRACT

A mobile device performs thermal management during concurrent battery charging and workload execution based on a thermal headroom. The thermal headroom is an amount of power, in a form of heat, that heat dissipation hardware in the mobile device is estimated to dissipate when the mobile device operates at a target temperature. After the thermal headroom is determined, the mobile device determines a first power allocation to system loading, which is caused by one or more applications running on the mobile device. The first power allocation is subtracted from the thermal headroom to obtain a second power allocation to a charger, which charges a battery module of the mobile device while the one or more application are running. The mobile device then sets an input power limit of the charger based on the second power allocation.

### CROSS-REFERENCE TO RELATED APPLICATIONS

This application claims the benefit of U.S. Provisional Application No. 62/364,903 filed on Jul. 21, 2016, the entirety of which is incorporated by reference herein.

### TECHNICAL FIELD

Embodiments of the invention relate to thermal management of a system that processes a workload while charging its battery.

### BACKGROUND

Modern portable devices are typically equipped with a rechargeable battery that can be repeatedly drained and charged over a lifespan of several years. A rechargeable battery is typically connected to a charger, which converts input voltage and current to a level compatible with the battery. An intelligent charger may optimize the charging process by initially charging the battery at the maximum rate until a preset temperature is reached, then slowing down or stopping the charge so as not to exceed the temperature limit. By monitoring the temperature and regulating the charging process, permanent damage to the battery can be avoided.

One main contributor to the rise in temperature during the charging process is the charger's inefficiency. A typical charger is not 100% efficient, which means that a portion of its input power is converted into heat instead of being stored in the battery. Some advanced chargers are provided with fast charging capabilities. A fast charger draws in an increased amount of power (e.g., at an increased level of input voltage and/or current) than a regular charger during the charging process. The increased input power causes an increased heat output, which further heightens the need for thermal management.

Modern portable devices, such as laptops, tablets, smartphones, and other consumer electronics, are designed to run system and user space applications while their batteries are being charged. Concurrent charging and application executions can rapidly raise the device temperature and negatively impact the performance of the applications.

Thus, there is a need for improvement in thermal management for rechargeable devices to allow for concurrent workload execution and fast charging.

### SUMMARY

In one embodiment, a method of thermal management is provided for a mobile device. The method comprises: determining a thermal headroom, which is an amount of power in a form of heat that heat dissipation hardware in the mobile device is estimated to dissipate when the mobile device operates at a target temperature; determining a first power allocation to system loading caused by one or more applications running on the mobile device; subtracting the first power allocation from the thermal headroom to obtain a second power allocation to a charger that charges a battery module of the mobile device while the one or more application are running; and setting an input power limit of the charger based on the second power allocation.

In another embodiment, a mobile device is provided to perform thermal management. The mobile device comprises a memory; one or more processors coupled to the memory; and a charger for charging a battery module of the mobile device. The one or more processors are operative to: determine a thermal headroom, which is an amount of power in a form of heat that heat dissipation hardware in the mobile device is estimated to dissipate when the mobile device operates at a target temperature; determine a first power allocation to system loading caused by one or more applications running on the mobile device; subtract the first power allocation from the thermal headroom to obtain a second power allocation to the charger while the one or more application are running; and set an input power limit of the charger based on the second power allocation.

The embodiments of the invention enable a system, such as a mobile device, to concurrently charge its battery and execute system workload without negative performance impact on the workload. Advantages of the embodiments will be explained in detail in the following descriptions.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an example of a system performing thermal management according to one embodiment.

FIG. 2 is a diagram illustrating power allocation according to one embodiment.

FIG. 3 illustrates an example of the system components that contribute to the determination of system loading according to one embodiment.

FIG. 4 is a flow diagram illustrating a thermal management process according to one embodiment.

FIG. 5 is a flow diagram illustrating a thermal headroom adjustment process according to one embodiment.

FIG. 6 is a flow diagram illustrating a method of thermal management according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a system and method for thermal management of a system that is concurrently charging its battery and executing its workload. The system includes a thermal manager, which controls the allocation of power to the charger and system loading with minimized system performance impact. The thermal manager optimally utilizes the thermal headroom provided by the system hardware, and may dynamically adjust the thermal headroom when the system temperature cannot be maintained at a target temperature. The target temperature is a temperature at which the system hardware can operate safely, as excessive temperature can degrade the performance, life, and reliability of the system.

The thermal headroom, as used herein, is the amount of power in the form of heat that heat dissipation hardware in the system is estimated to dissipate when the system operates at a target temperature. The amount of thermal headroom that a system has may be calibrated and estimated by a hardware manufacturer, and provided to system designers as a default value with an error margin. The thermal headroom may be specified by the hardware manufacturer as a given power value; e.g., N watts. In one embodiment, the system may allocate a portion of the N watts to the power loss of the charger caused by charging inefficiency, and another portion of the N watts to workload execution. In one embodiment, the workload execution has a higher priority in the allocation of the N watts over the charging inefficiency. Prioritizing workload execution optimizes system performance during the charging process.

However, during system operation, there are various factors that may cause the system temperature to deviate from the target temperature; for example, the environment in which the system operates, whether the heat generating components in the system are spaced apart or concentrated in one area, etc. If the heat dissipation hardware does not bring the system to the target temperature, the thermal headroom may be adjusted based on the amount of temperature deviation from the target temperature. An operating temperature higher than the target temperature may damage the system hardware, and an operating temperature lower than the target temperature means that more power may be allocated to the system; e.g., more power may be allocated to the power loss of the charger, thereby allowing the charging speed to increase.

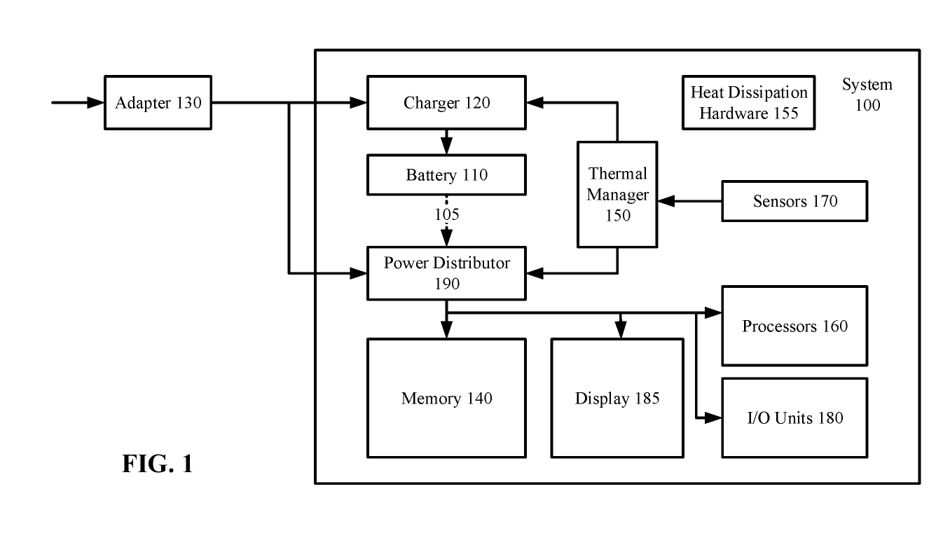

FIG. 1 illustrates an example of a system 100 that performs thermal management according to one embodiment. The system 100 includes a rechargeable battery 110, which can be recharged by a charger 120 in the system 100 through an adapter 130. In one embodiment, the adapter 130 converts household electric current from a distribution voltage (e.g., in the range 100 to 240 volts alternating current (AC)) to direct current (DC) in a low voltage range suitable for the system 100. In one embodiment, the power input to the system 100 is allocated to the battery 110 and other parts of the system 100 under the command of a thermal manager 150.

In one embodiment, the system 100 further includes a memory 140, such as a combination of volatile memory and non-volatile memory, and one or more processors 160, such as central processing units (CPUs), graphics processing units (GPUs), and/or other types of special-purpose and general-purpose processors. The system 100 also includes a display 185 and/or other I/O units 180; e.g., a touch screen, a keyboard, a home button, a touch pad, etc. Non-limiting examples of the system 100 may include smartphone, laptop, smartwatch, or other portable or wearable devices.

In one embodiment, the system 100 includes a power distributor 190 to distribute power to the functional components (e.g., processors 160, memory 140, display 185, I/O units 180, etc.) of the system 100. The power distributor 190 may receive power through the adapter 130 from a power outlet, and distribute power to the functional components for their operations. When the system 100 is not plugged into a power outlet, the power distributor 190 receives power from the battery 110 (e.g., via a path 105). The charger 120 and the power distributor 190 may concurrently receive power from the adapter 130 when the system 100 is plugged into a power outlet; for example, when the battery 110 is charging and the functional components are also executing a workload. In one embodiment, the thermal manager 150 determines the amount of power supplied to the charger 120 to charge the battery 110 and the amount of power supplied to the functional components for executing the workload.

In one embodiment, the charger 120 is not 100% efficient when it charges the battery 110. That is, when the charger 120 sends power to the battery 110 to store electric charges in the battery cells, a portion of the power is lost (e.g., to chemical reactions) in the form of heat. The term “charging inefficiency” refers to the percentage of lost power by the charger 120 over its received power when charging the battery 110. In one embodiment, the charging inefficiency stays substantially the same (e.g., 10%) for a range of power levels received at the input of the charger 120. That is, if the charger 120 receives 10 watts of input power, 1 watt of power is lost in the form of heat due to charging inefficiency. Thus, the higher the input power level is, the more heat is generated due to the charging inefficiency.

In addition to the charging inefficiency, the system 100 also generates heat due to system loading; i.e., the workload executed by its functional components. The system 100 is designed to safely operate at or below a target temperature. To maintain the temperature at or below this target temperature, the system 100 includes heat dissipation hardware 155 (e.g., cooling fans, heat pipes, etc.) for dissipating a predetermined amount of heat over a given time period. Thermal headroom is the amount of power in the form of heat that heat dissipation hardware 155 is estimated to dissipate when the system 100 operates at the target temperature. To ensure safe operation of the system 100, the power allocation of the system 100, including system loading and power loss from charging inefficiency, is kept within the system's thermal headroom.

The system 100 further includes a number of sensor 170, such as temperature sensors to monitor the temperature within the system, the printed circuit board (PCB) or the system-on-a-chip (SoC) on which the system 100 is located, and the like. The measured system temperature can be used to adjust the thermal headroom, the system power allocation, and/or the power input to the charger 120.

In one embodiment, the system 100 provides a fast charging mode, which draws a higher amount of current (e.g., higher than a threshold) into the charger 120 than a regular charging mode. The input voltage to the charger 120 may be fixed, variable, or tiered across the different charging modes. The faster charging time is enabled by a higher amount of power that the charger 120 receives at its input. However, more power is lost due to charging inefficiency in the fast charging mode than in the regular charging mode.

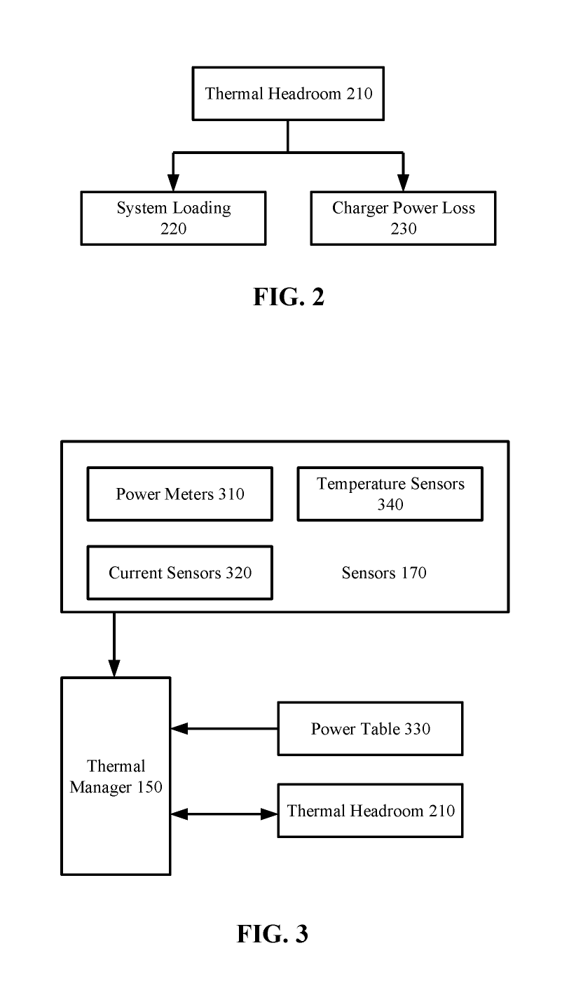

The system 100 may execute a system workload when charging the battery 110. This system workload is also referred to as system loading. For example, the system 100 may execute a gaming application, display a video, or perform other power-consuming operations in the system space or the user space. FIG. 2 is a diagram illustrating the power allocation performed by the system 100 for thermal management according to one embodiment. In one embodiment, the thermal manager 150 may allocate power from a given thermal headroom 210 to both system loading 220 and charger power loss 230 due to charging inefficiency. In one embodiment, the system loading 220 is prioritized for power allocation over the charger power loss 230.

In one embodiment, given the thermal headroom 210 (e.g., provided by a hardware manufacturer) and an estimation of the system loading 220, the charger power loss 230 can be calculated by subtracting the system loading 220 from the thermal headroom 210. Since the charging inefficiency is known (e.g., provided by a hardware manufacturer), the amount of power input to the charger 110 can be calculated by dividing the charger power loss 230 by the charging inefficiency.

FIG. 3 illustrates an example of the system components that contribute to the determination of the system loading 220 according to one embodiment. In this example, the system loading 220 may be determined by one or more sensors 170 including but not limited to: power meters 310, current sensors 320, etc. The power meters 310 and the current sensors 320 can be used to measure or estimate the power consumed by the functional components of the system 100 during operation. For example, when a user is playing a game, the power meters 310 and/or the current sensors 320 can measure the power consumed by the processors (e.g., CPUs and GPUs) and the display. Additionally or alternatively, the thermal manager 150 may read data from one or more power tables 330, where the data has been calibrated to show the typical or average amount of power consumption for the system loading 220 under different scenarios.

In one embodiment, the sensors 170 also include temperature sensors 340, which monitor the temperature in the system 100 to ensure safe operation of the system 100. The output of the temperature sensors 340 may be relied on for adjusting the thermal headroom 210, as will be described in more detail with reference to FIG. 5.

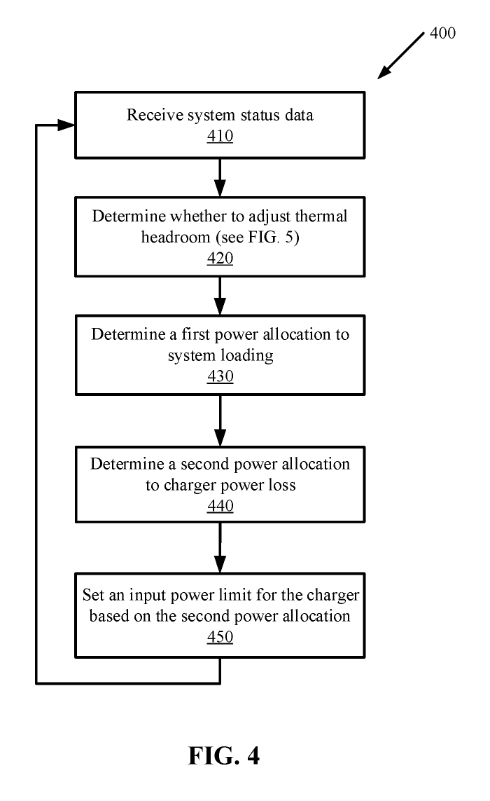

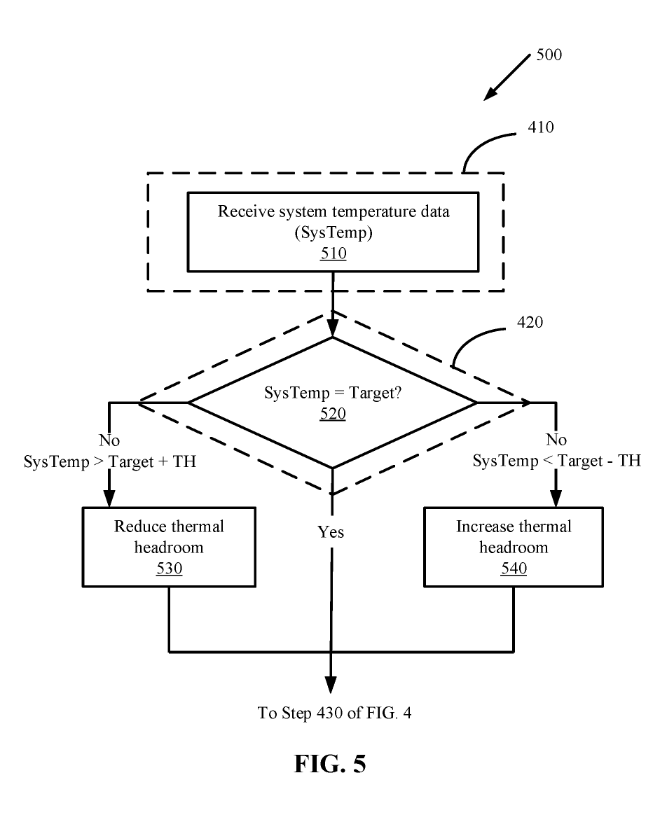

FIG. 4 is a flow diagram illustrating a thermal management process 400 according to one embodiment. The process 400 may be performed by a system (e.g., the system 100 of FIG. 1, or more specifically, the thermal manager 150 of FIG. 1). In one embodiment, the process 400 may be performed when the system 100 is in active operation (e.g., executing system and/or user applications) and in a charging mode (e.g., the fast charging mode).

The process 400 begins with the thermal manager 150 receiving system status information at step 410. The system status information includes temperature information. Using the temperature information, the thermal manager 150 determines whether to adjust the thermal headroom at step 420. Detailed operations of step 420 are described in connection with FIG. 5. If the thermal headroom does not need adjustment or if the thermal headroom has been adjusted, the process 400 proceeds to step 430 at which the thermal manager 150 determines the power requirement for system loading from the received system status information such as the power meter measurement, current sensor measurement, power table reading, etc. Accordingly, the thermal manager 150 determines a first power allocation to system loading. At step 440, the thermal manager 150 determines a second power allocation to the charger 120 for charger power loss. In one embodiment, the second power allocation is the thermal headroom minus the first power allocation. At step 450, the thermal manager 150 sets an input current limit to the charger 120 according to the second power allocation. For example, if the second power allocation is 2 watts and the power inefficiency is 10%, then the input power is limited to 20 watts. Additionally, if the input voltage for the fast charging mode is 5 volt, then the input current will be limited to no more than 20 (watts)/5 (volts)=4 amps. The process 400 may iterate steps 410-450 to continuously adjust the input power to the charger.

FIG. 5 is a flow diagram illustrating an adjustment process 500 for the thermal headroom according to one embodiment. The process 500 may be performed by a system (e.g., the system 100 of FIG. 1, or more specifically, the thermal manager 150 of FIG. 1). In one embodiment, the process 500 may be performed when the system 100 is in active operation (e.g., executing system and/or user applications) and in a charging mode (e.g., the fast charging mode). In FIG. 5, the dotted blocks indicate the corresponding elements or steps in FIG. 4.

The process 500 begins with the thermal manager 150 receiving system temperature data (“SysTemp”) at step 510; e.g., from the temperature sensors 340 of FIG. 3. Step 510 may be part of step 410 of FIG. 4 at which system status data is received. In one embodiment, the thermal manger 150 may obtain SysTemp by taking the average, the weighted average, or the maximum of the temperature measurements from multiple temperature sensors 340 and/or from multiple time instants over a time period. Step 520 may be part of step 420 of FIG. 4 at which the thermal manager 150 determines whether or not to adjust the thermal headroom. If, at step 520, SysTemp is equal to a predetermined target temperature (or is within a tolerance value from the target temperature), the process 500 proceeds to step 430 of FIG. 4 to determine power allocation. If, at step 520, SysTemp is different from the target temperature by at least a threshold value (“TH”); e.g., 1° C., the process 500 proceeds to step 530 or step 540 to adjust the thermal headroom.

More specifically, if SysTemp is greater than the target temperature by TH, the thermal headroom is decreased at step 530. A higher-than-target temperature means that the power allocated to the heat generating components in the system 100 is more than the capacity of the heat dissipating hardware. In some cases if the temperature issue is not resolved in time, the system temperature may keep increasing and cause permanent damage to the system hardware.

If SysTemp is less than the target temperature by TH, the thermal headroom is increased at step 540. In some cases SysTemp may stay at a stable temperature below the target temperature, or in some other cases SysTemp may continue to decrease below the target temperature. That is, the system temperature does not reach the target temperature during concurrent workload execution and battery charging. A lower-than-target temperature means that the power allocated to the heat generating components in the system 100 is less than the capacity of the heat dissipating hardware, and it also means that more power may be allocated to the heating generating components. Since the system loading is given priority over the charger power loss in power allocation, the increased thermal headroom may be provided to the charger such that the charger is allowed to draw in more power and charge at a faster rate. The process 500 proceeds from step 530 or step 540 to step 430 of FIG. 4 to use the adjusted thermal headroom for power allocation.

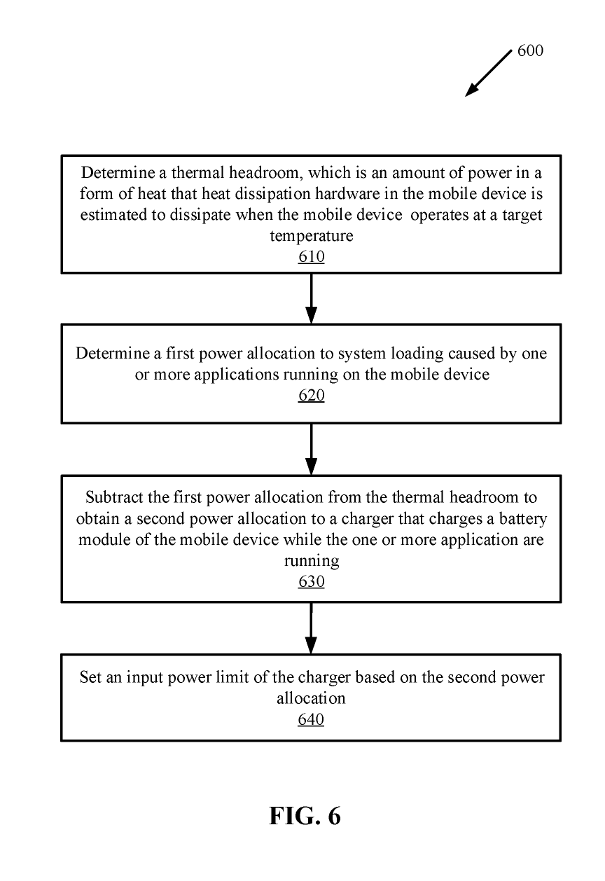

FIG. 6 is a flow diagram illustrating a method 600 of thermal management for a mobile device according to one embodiment. The method 600 begins with a system determining a thermal headroom, which is an amount of power in a form of heat that heat dissipation hardware in the mobile device is estimated to dissipate when the mobile device operates at a target temperature (step 610). The system determines a first power allocation to system loading caused by one or more applications running on the mobile device (step 620). The system subtracts the first power allocation from the thermal headroom to obtain a second power allocation to a charger that charges a battery module of the mobile device while the one or more application are running (step 630). The system sets an input power limit of the charger based on the second power allocation (step 640).

In one embodiment, the method 600 may be performed by a processing system, such as the system 100 of FIG. 1. In one embodiment, the method 600 may be performed by the thermal manager 150 of FIG. 1, which may be hardware (e.g., circuitry, dedicated logic, programmable logic, microcode, etc.), software (e.g., instructions that run on one or more processors), firmware, or a combination thereof.

The operations of the flow diagrams of FIGS. 4-6 have been described with reference to the exemplary embodiment of FIG. 1. However, it should be understood that the operations of the flow diagrams of FIGS. 4-6 can be performed by embodiments of the invention other than the embodiment discussed with reference to FIG. 1, and the embodiment discussed with reference to FIG. 1 can perform operations different than those discussed with reference to the flow diagrams. While the flow diagrams of FIGS. 4-6 show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method of thermal management for a mobile device, comprising:
determining a thermal headroom, which is an amount of power in a form of heat that heat dissipation hardware in the mobile device is estimated to dissipate when the mobile device operates at a target temperature;
determining a first power allocation to system loading caused by one or more applications running on the mobile device;
subtracting the first power allocation from the thermal headroom to obtain a second power allocation to a charger that charges a battery module of the mobile device while the one or more application are running; and
setting an input power limit of the charger based on the second power allocation.

2. The method of claim 1, wherein setting the input power limit further comprises:
dividing the second power allocation by an inefficiency percentage of the charger and by an input voltage level to obtain an input current level.

3. The method of claim 1, wherein determining the thermal headroom further comprises:
detecting that the mobile device operates at a temperature below the target temperature; and
increasing the thermal headroom.

4. The method of claim 3, further comprising:
adjusting the input power limit of the charger.

5. The method of claim 1, wherein determining the thermal headroom further comprises:
detecting that the mobile device operates at a temperature above the target temperature; and
decreasing the thermal headroom.

6. The method of claim 5, further comprising:
adjusting the input power limit of the charger.

7. The method of claim 1, further comprising:
continuously monitoring the system loading to thereby adjust the first power allocation and the second power allocation while charging the mobile device.

8. The method of claim 6, further comprising:
continuously adjusting the input power limit of the charger in response to adjustment to the first power allocation and the second power allocation to thereby maintain the target temperature.

9. The method of claim 1, further comprising:
prioritizing the system loading over the charger with respect to power allocation to thereby maintain performance of the one or more applications.

10. The method of claim 1, further comprising:
estimating the system loading based on one or more of: a power meter measurement, a current sensor measurement, and a power table reading.

11. A mobile device that performs thermal management, comprising:
a memory;
one or more processors coupled to the memory; and
a charger for charging a battery module of the mobile device, the one or more processors operative to:
determine a thermal headroom, which is an amount of power in a form of heat that heat dissipation hardware in the mobile device is estimated to dissipate when the mobile device operates at a target temperature;
determine a first power allocation to system loading caused by one or more applications running on the mobile device;
subtract the first power allocation from the thermal headroom to obtain a second power allocation to the charger while the one or more application are running; and
set an input power limit of the charger based on the second power allocation.

12. The mobile device of claim 11, wherein the one or more processors are operative to:
divide the second power allocation by an inefficiency percentage of the charger and by an input voltage level to obtain an input current level.

13. The mobile device of claim 11, wherein the one or more processors are operative to:
detect that the mobile device operates at a temperature below the target temperature; and
increase the thermal headroom.

14. The mobile device of claim 13, wherein the one or more processors are operative to:
adjust the input power limit of the charger.

15. The mobile device of claim 11, wherein the one or more processors are operative to:
detect that the mobile device operates at a temperature above the target temperature; and
decrease the thermal headroom.

16. The mobile device of claim 15, wherein the one or more processors are operative to:
adjust the input power limit of the charger.

17. The mobile device of claim 11, wherein the one or more processors are operative to:
continuously monitor the system loading to thereby adjust the first power allocation and the second power allocation while charging the mobile device.

18. The mobile device of claim 16, wherein the one or more processors are operative to:
continuously adjust the input power limit of the charger in response to adjustment to the first power allocation and the second power allocation to thereby maintain the target temperature.

19. The mobile device of claim 11, wherein the one or more processors are operative to:
prioritize the system loading over the charger with respect to power allocation to thereby maintain performance of the one or more applications.

20. The mobile device of claim 11, wherein the one or more processors are operative to:
estimate the system loading based on one or more of: a power meter measurement, a current sensor measurement, and a power table reading.
